(19) United States
(12) Patent Application Publication
(10) Pub. No.: US 2013/0110566 A1
(43) Pub. Date: May 2, 2013

(54) EVALUATION TOOL AND PROCESS

(71) Applicant: Luís Miguel SOUSA SOBRAL, Alcochete (PT)

(72) Inventor: Luís Miguel SOUSA SOBRAL, Alcochete (PT)

(21) Appl. No.: 13/547,903

(22) Filed: Jul. 12, 2012

(30) Foreign Application Priority Data
Jul. 12, 2011 (PT) 105806

(51) Int. Cl. G06Q 10/06

(52) U.S. Cl. CPC G06Q 10/0631
USPC 705/7.12

(57) ABSTRACT

A multiple criteria, multi-level evaluation method or tool, for proposals from bids in a purchasing process, can include defining an evaluation team or teams, defining which individuals of the team evaluate which metrics, resolving possible conflicts between different scores by different individuals and/or teams for the same metrics, defining which criteria to use in order to aggregate scores—minimum, maximum, average, manually, and establishing scoring functions for each variable and aggregation functions for establishing overall scores.

### CROSS-REFERENCE TO RELATED APPLICATIONS

### Related Case Information

This application claims the priority benefit under 35 U.S.C. §119 of Portuguese Patent Application No. PT 105806 filed on Jul. 12, 2011, which is hereby incorporated in its entirety by reference.

### BACKGROUND

### Field of the Disclosed Subject Matter

The subject matter pertains namely to a multiple criteria, multi-level evaluation method or tool, for proposals from bids in a purchasing process.

### SUMMARY OF THE DISCLOSED SUBJECT MATTER

### Background Art

The present invention describes a multiple criteria, multi-level evaluation tool, namely for proposals from bids in a purchasing process. It comprises defining an evaluation team or teams, defining which individuals of the team evaluate which metrics, resolving possible conflicts between different scores by different individuals and/or teams for the same metrics, defining which criteria to use in order to aggregate scores—minimum, maximum, average, manually.

It also comprises establishing scoring functions for each variable and aggregation functions for establishing overall scores. This aggregation will typically be highly hierarchical merging scores from multiple variable levels. Typically an evaluation model is a tree with scored leaf variables and branches which aggregate the respective leaf scores. The scoring functions can typically be continuous or discrete, linear or step-wise functions.

All these functions and aggregations can be saved in evaluation models and thus reused in subsequent procedures. In fact, when initiating a purchasing procedure, the buyer may even predefine the evaluation model. If the model is published, potential bidders may use the system to estimate scores for different scenarios and thus optimize a bid. Obviously, in these objective variables can be automatically input from the bid, but subjective or qualitative variables must be manually input by the bidder anticipating possible evaluation scenarios by the buyer.

### BRIEF DESCRIPTION OF THE SEVERAL VIEWS OF THE DRAWING

The figures are provided as illustrations which facilitate an understanding of the invention and are not to be seen as limiting the scope of the invention, but merely illustrating some of the exemplary embodiments of the invention.

FIG. 1 describes an evaluation module which is a specific (optional) module of nextway platform, which enables users that have it to fully integrate their evaluation process with the procurement process (Marketplace Module).

FIG. 2 describes how a procurement process can be made without using the evaluation module, with buyer making all decisions manually; when using the eValuation module, several value added decision tools are given to the buyer, that will help him select the best reply from suppliers; white boxes explain the procurement procedure flow without using evaluation module; thick lined boxes explain how the evaluation module integrates in the Marketplace module flow. There is no rule that makes it mandatory for buyer to communicate the Evaluation Model to the market. This means that, when buyer decides not to communicate the Evaluation Model to the market, the Evaluation Model can be modified at any time, until the award decision is taken.

FIG. 3 describes how the Evaluation Model comprises all information regarding evaluations, from the creation of evaluation systems and its components to the execution of specific evaluations on a specific request. Evaluation systems are the basis of all evaluation process in the platform. An evaluation system is created from a library of components (scores, question types, value functions/value function types, criteria and evaluation scales). Filtering the components of an evaluation system we are able to create weighting criteria models. If needed, we can use components from an external evaluation system. Weighted models are made available as templates and will be used by companies in specific requests.

A variable is a generic value that will be used in a value function formula to calculate the value of a specific criteria.

Variables are needed to make models universal and reusable. In specific requests, variables are transformed in specific values.

A criteria is something with specific characteristics that we want to evaluate in a reply, to decide which is the best reply.

A value function is how a criteria is evaluated, transforming a reply value into an evaluation score. An evaluation score is based on a continuous function, a discrete function or a mathematical function.

FIG. 4 describes when a weighted model template is applied in a specific request, we talk of a request evaluation model. In the evaluation model, each criteria is given a specific weight, that is, what is the importance of that criteria for the overall evaluation score (Sum of all weights must be 100%). Each selected criteria as associated a value function to transform input values into evaluation scores. To gather the values that will be evaluated in the criteria value function, one or more questions are associated to the criteria. There are several types of questions available, some with direct single answers, others with complex and/or multiple answers. Questions are filled by the repliers (for instance, what is the global price of your proposal). In some specific cases, criteria can be analyzed based on internal indicators (for instance, supplier classification in the internal suppliers system. In some cases, question answers might need to be “analyzed” by an evaluation system, so that a value is obtained, that can be evaluated by the value function and give a final score to that criteria.

FIG. 5 describes how received replies need to be evaluated. To evaluate a question, it must be associated with a criteria. Question answers can be simple. In this case, to the answer value we apply the associated criteria value function, to get the evaluation score for that question. On the other hand, some questions can be complex. In this case, we must use a specific question evaluation model, to transform that complex answer into a simple answer that the value function can transform into a score. An example of complex answer is a price list/bill of quantities, where we first need to evaluate each item price (eventually even select which items to consider), to get a global price. The global price of the list is then converted into a score. Another example is a requirements matrix, where we first need to score each requirement, so that we can get a global requirements value, that can be transformed into a final criteria score.

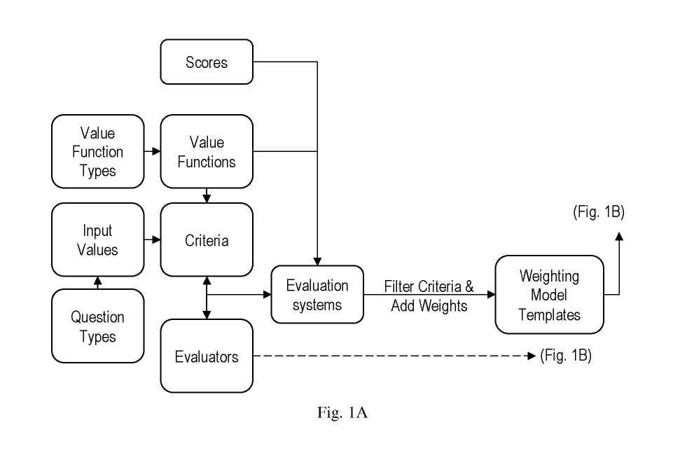

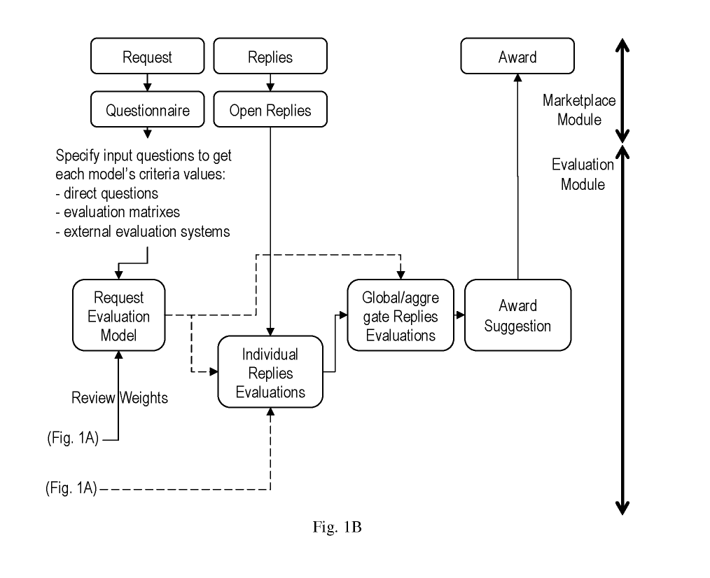

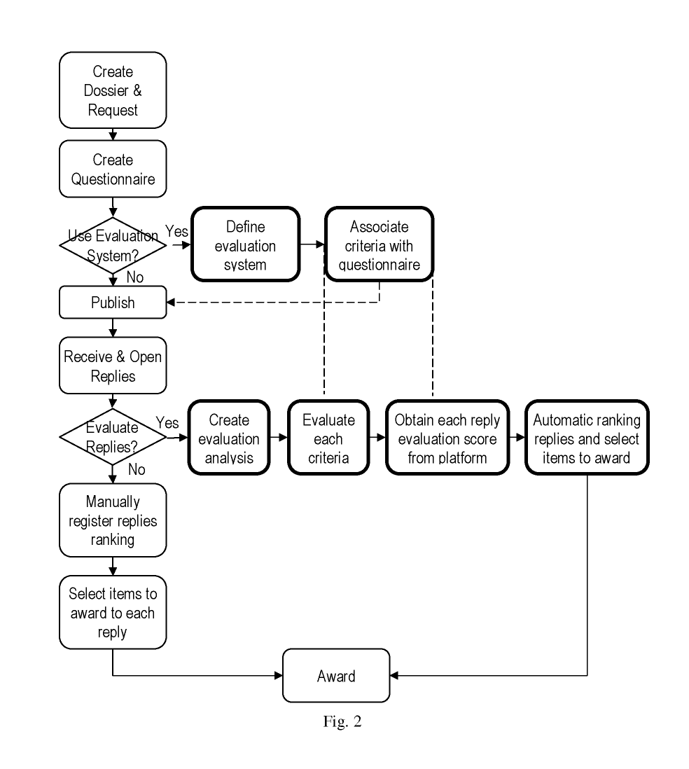

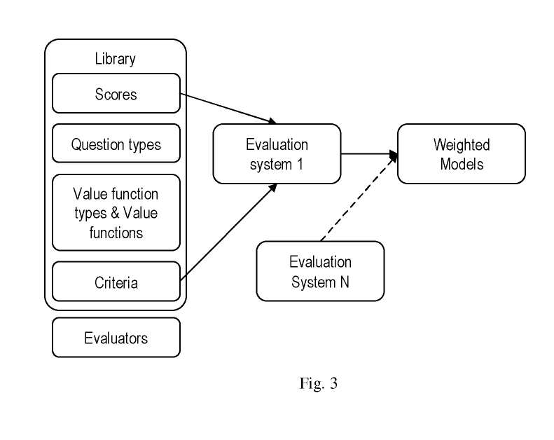

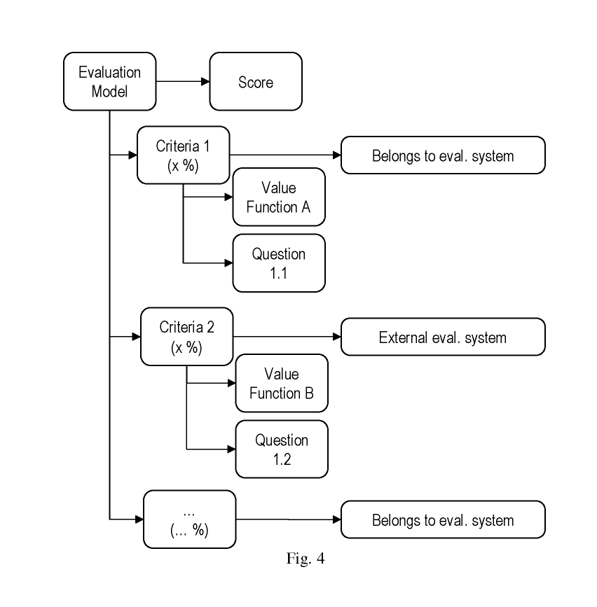

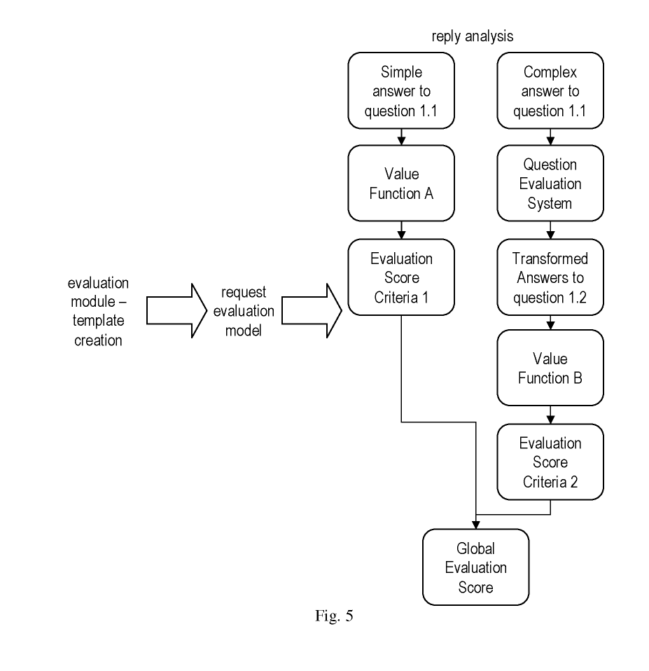

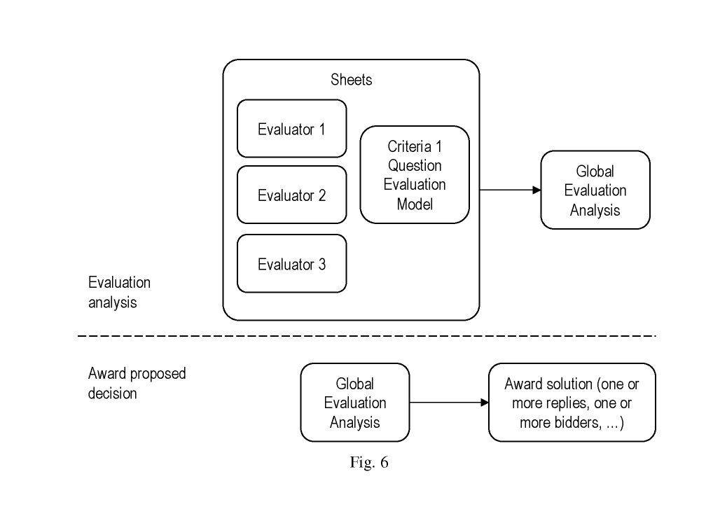

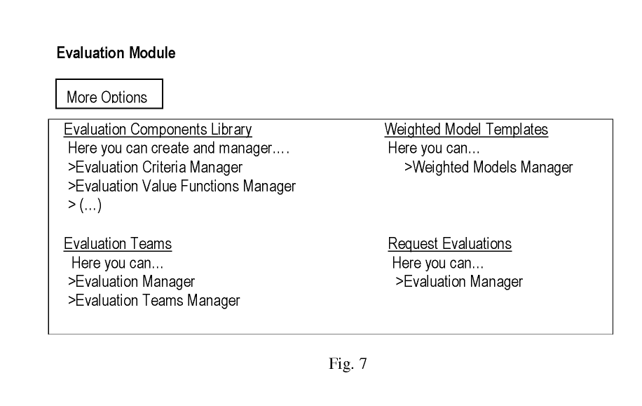

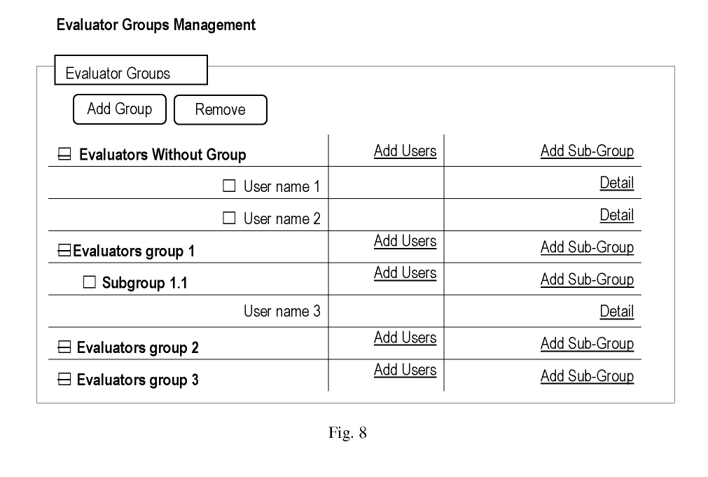

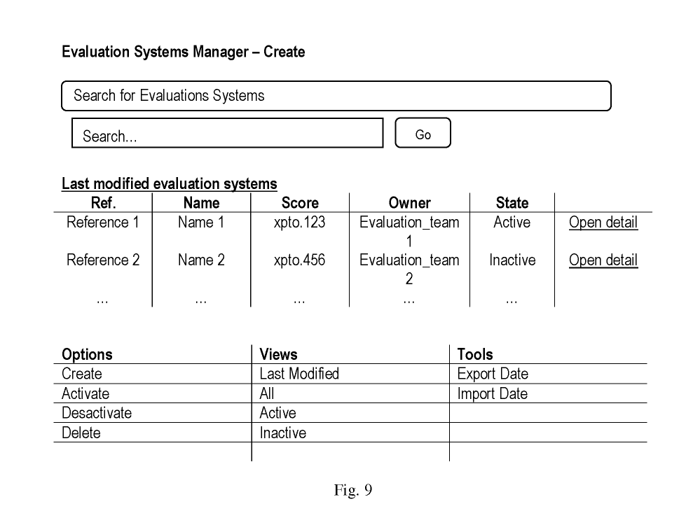

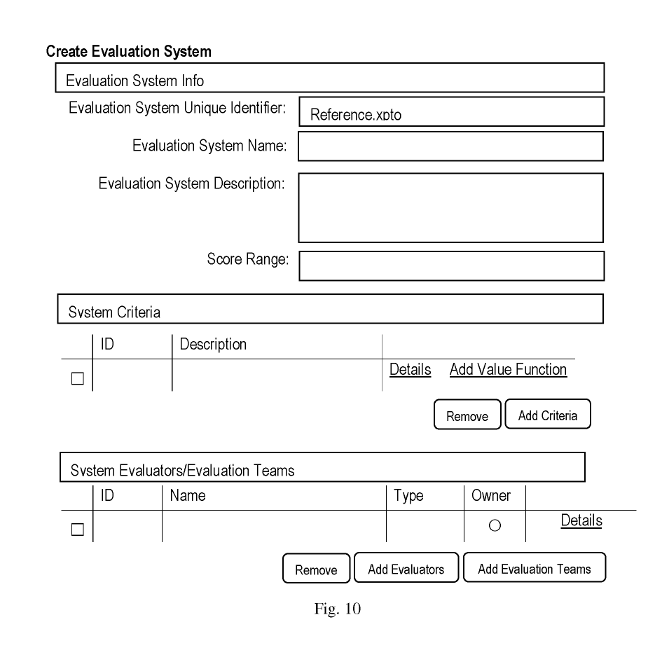

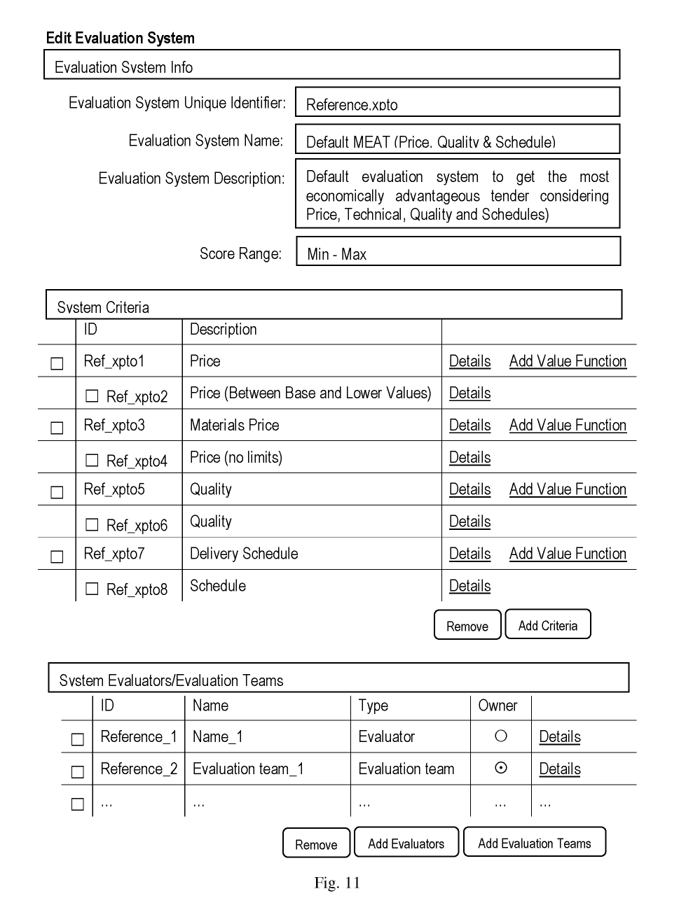

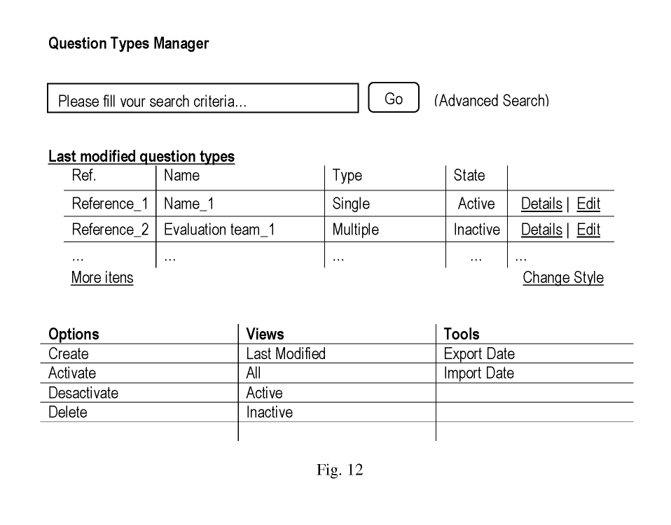

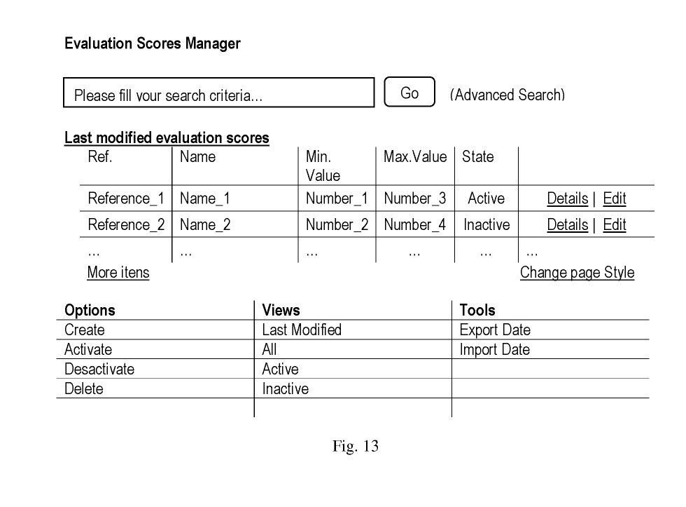

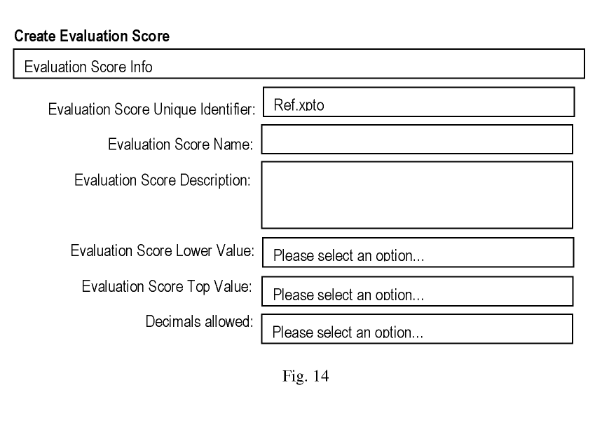

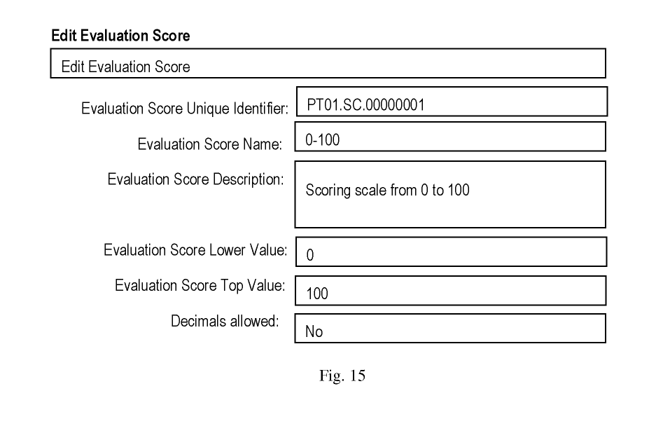

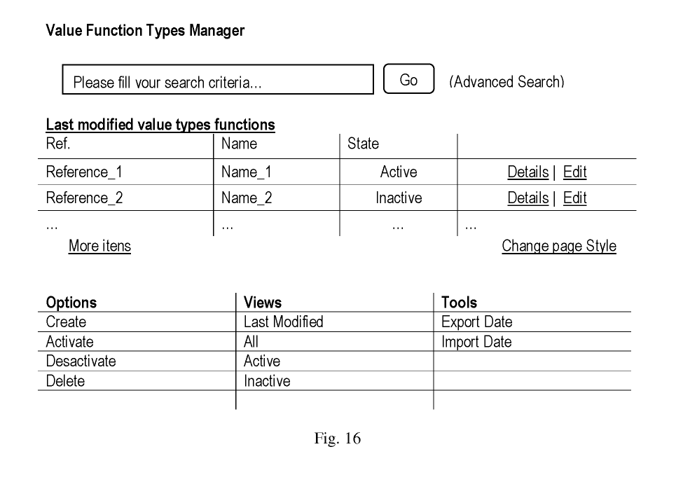

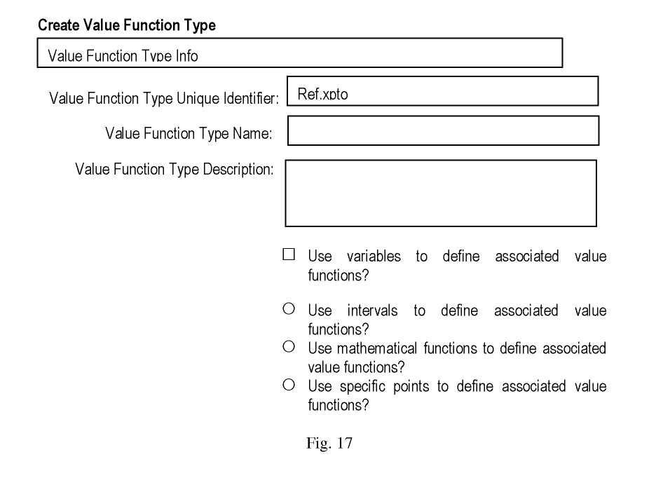

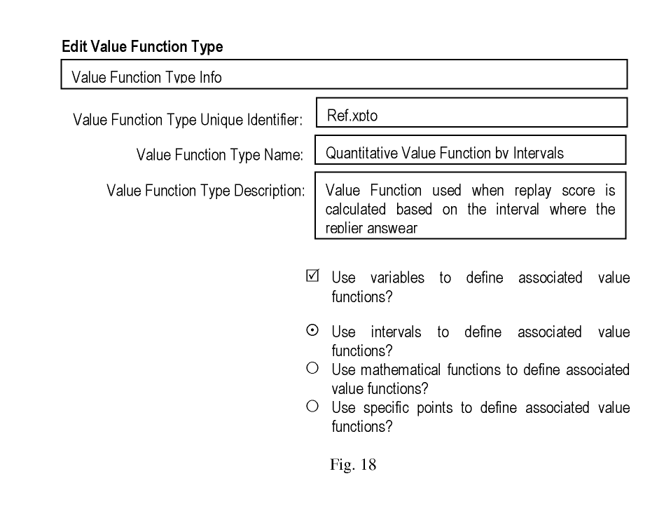

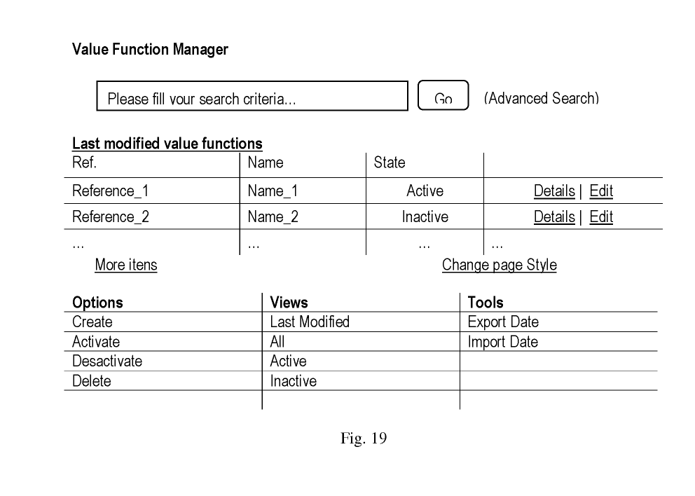

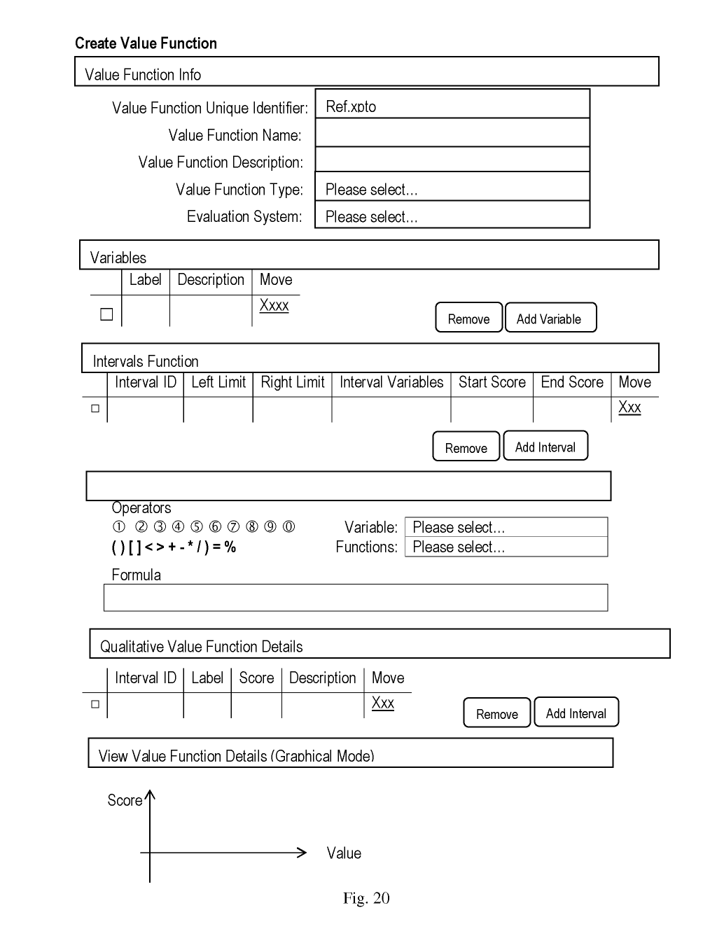

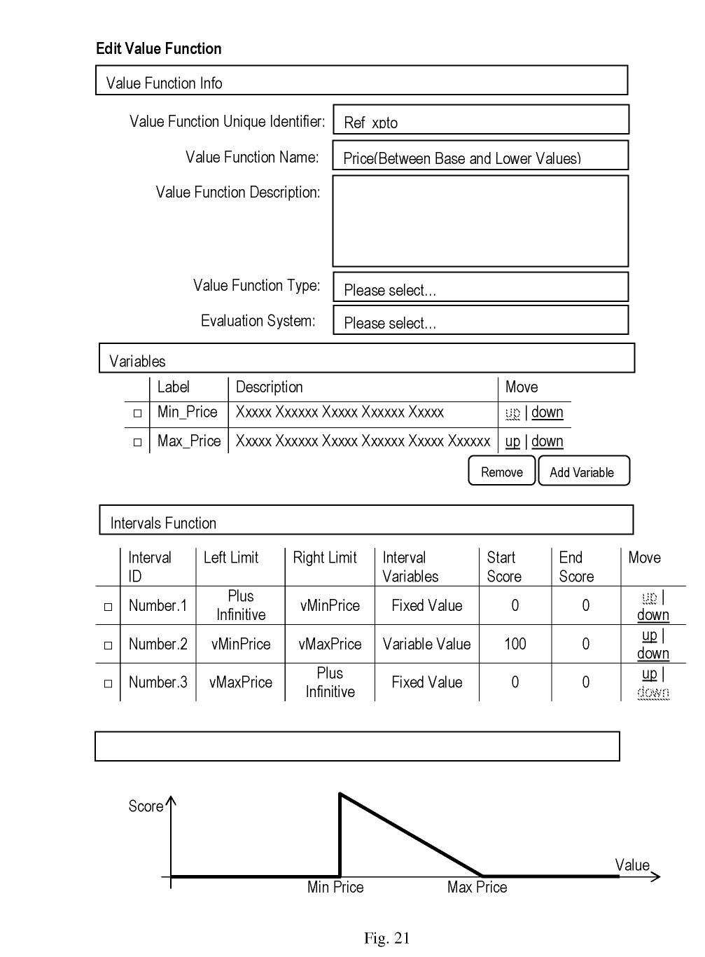

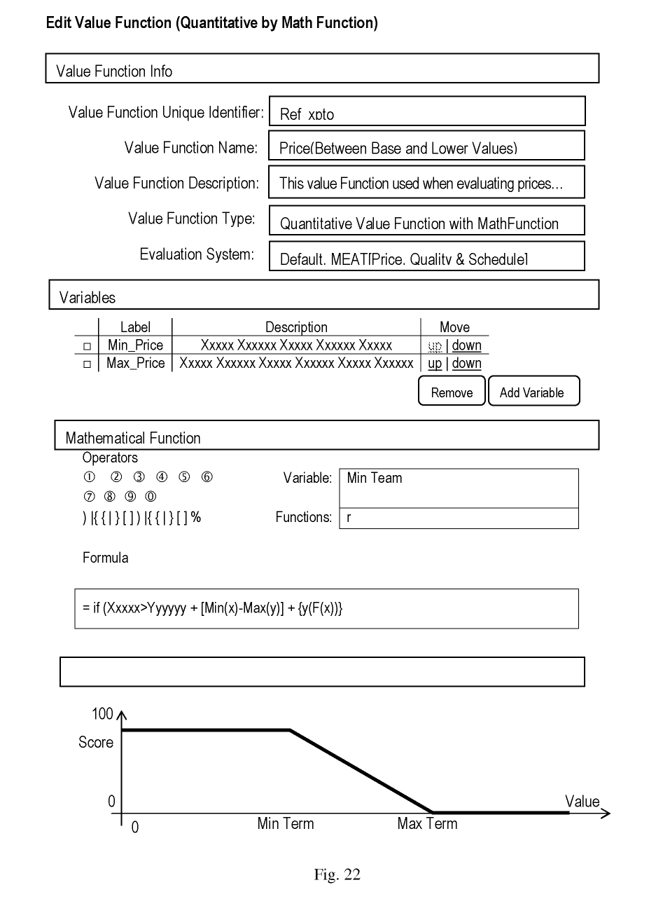

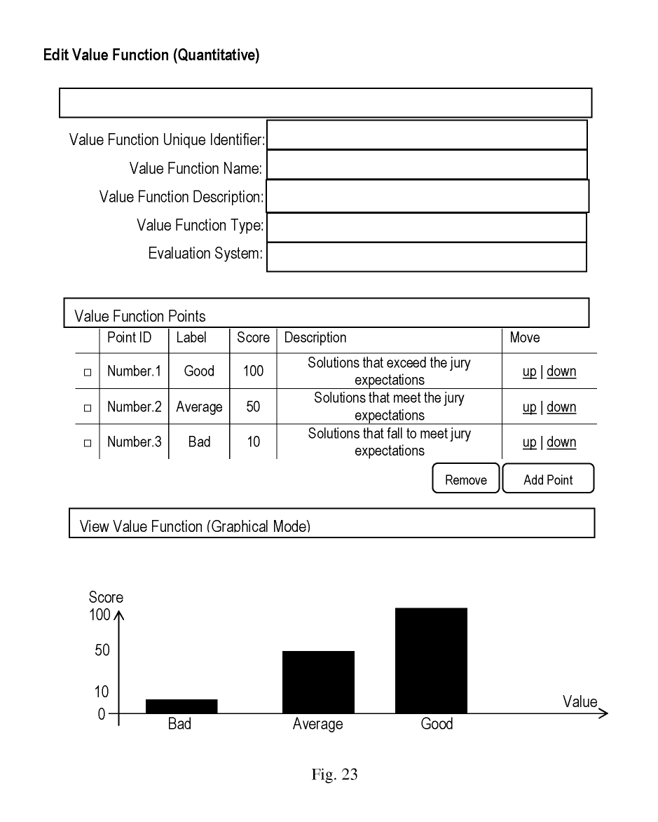

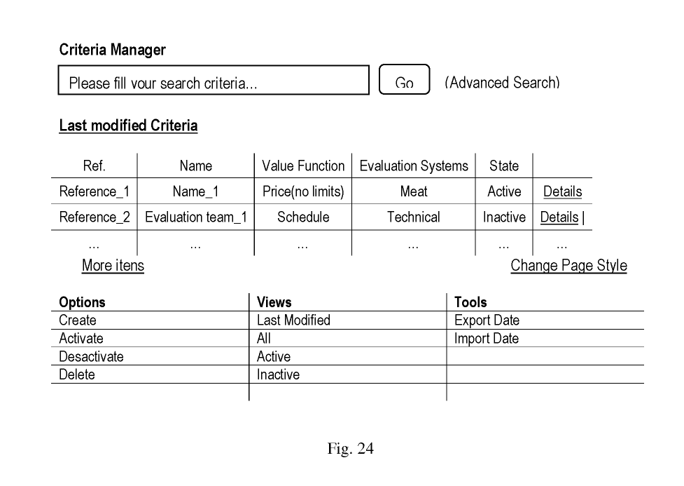

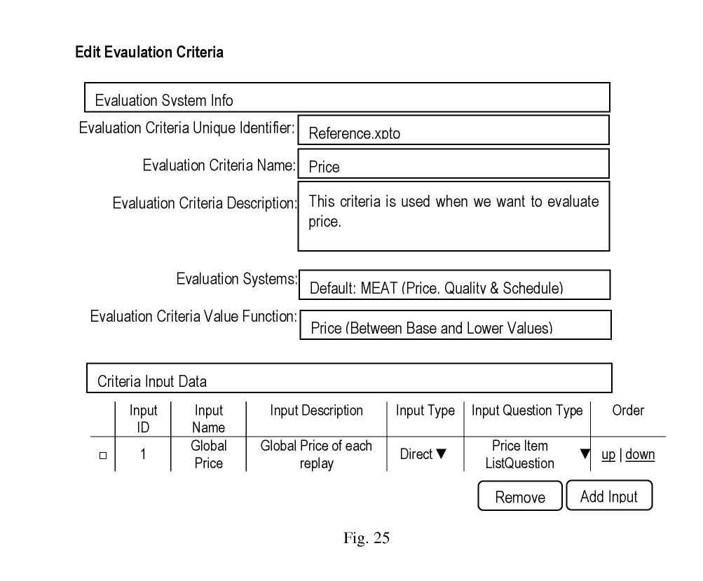

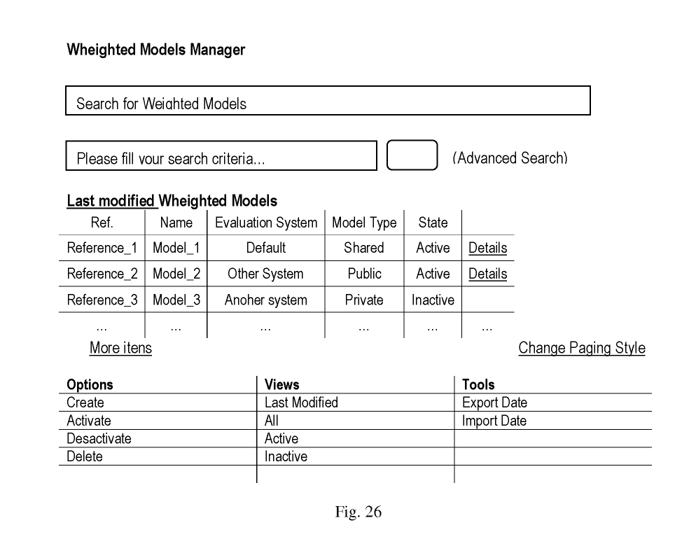

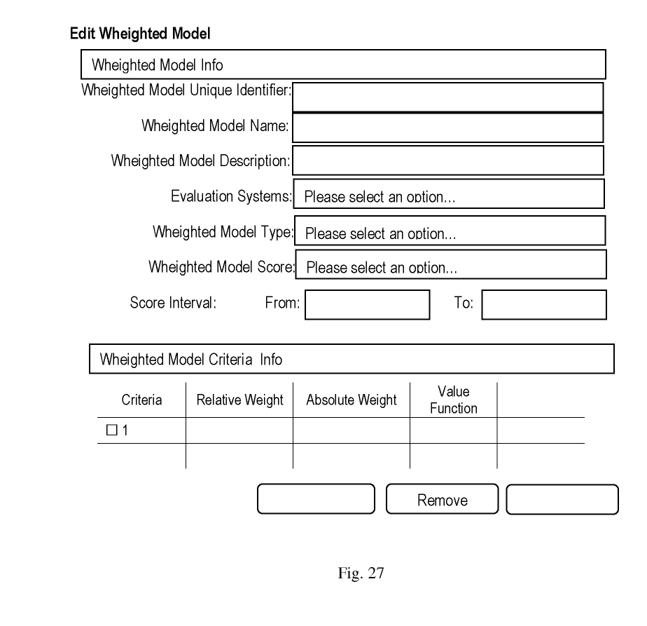

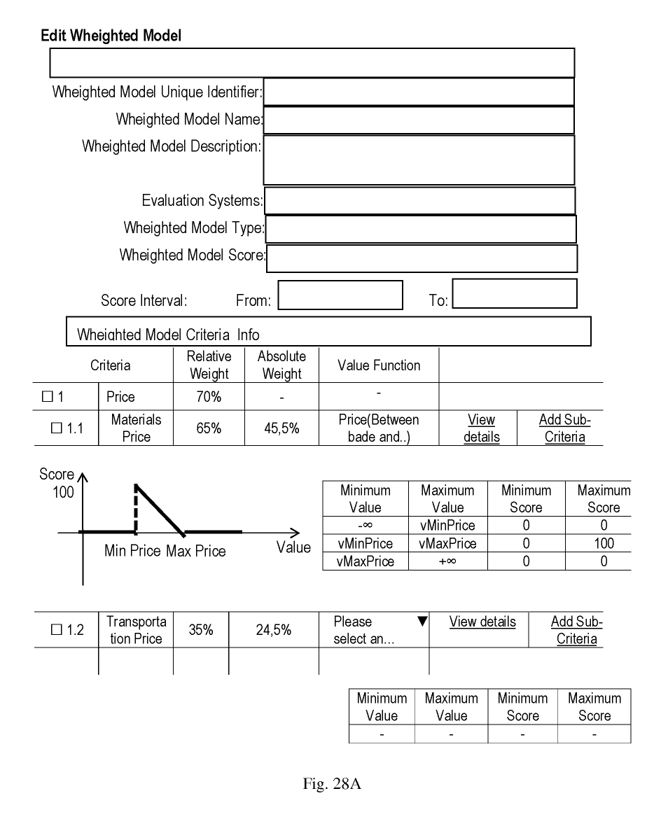

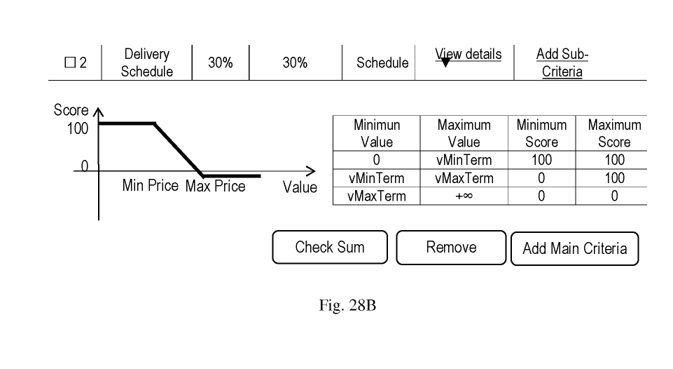

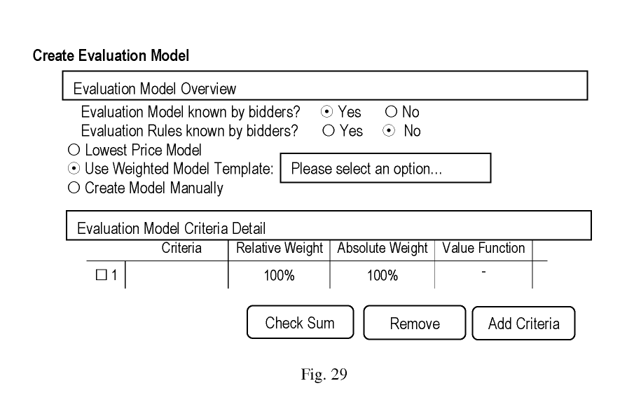

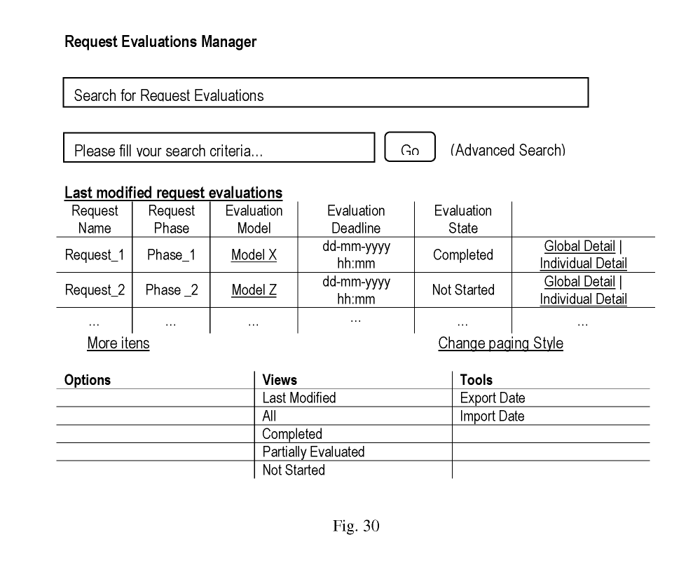

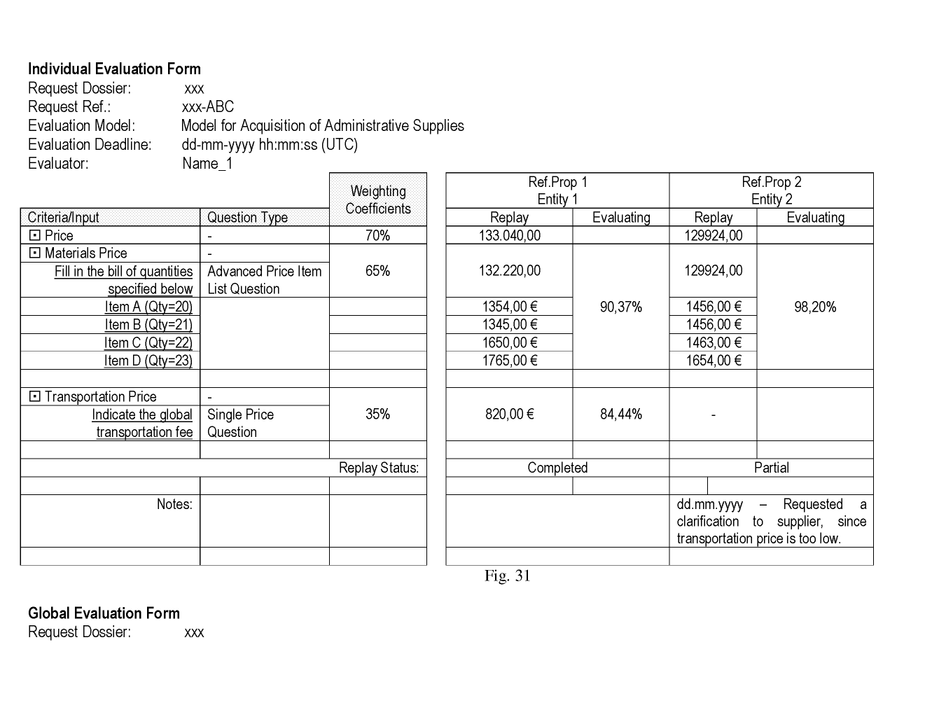

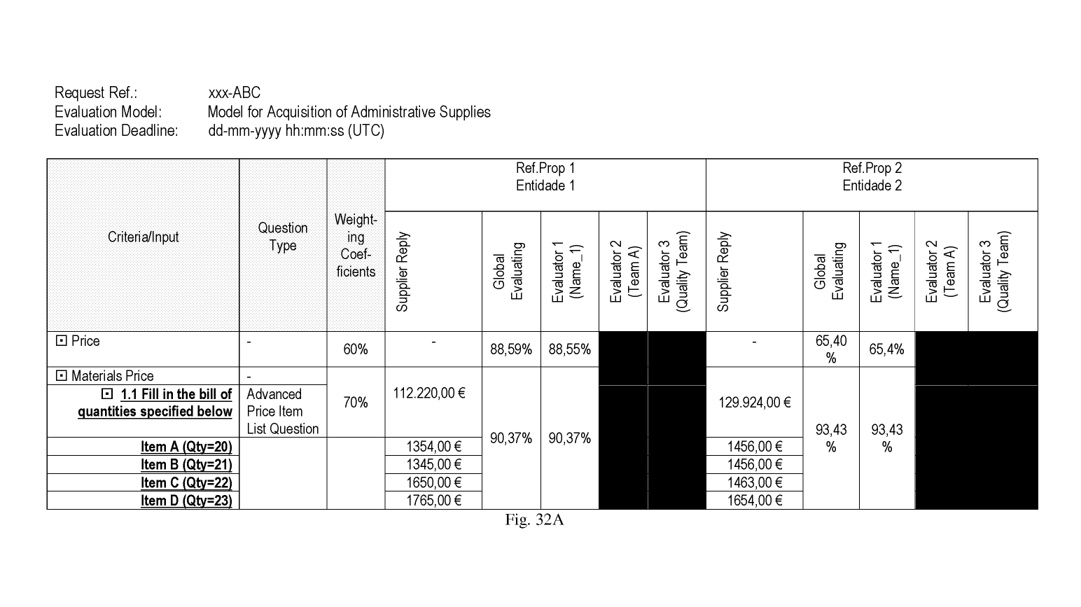

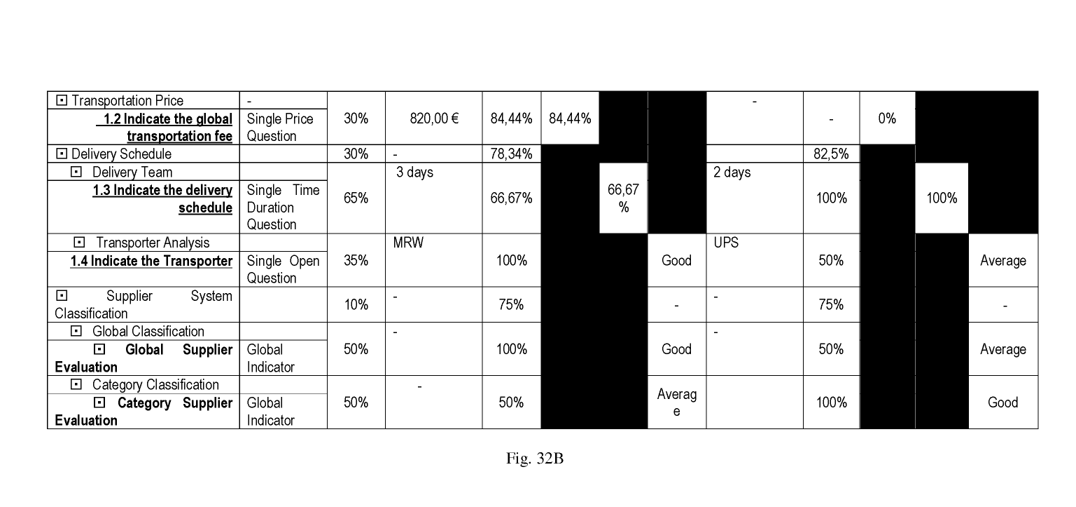

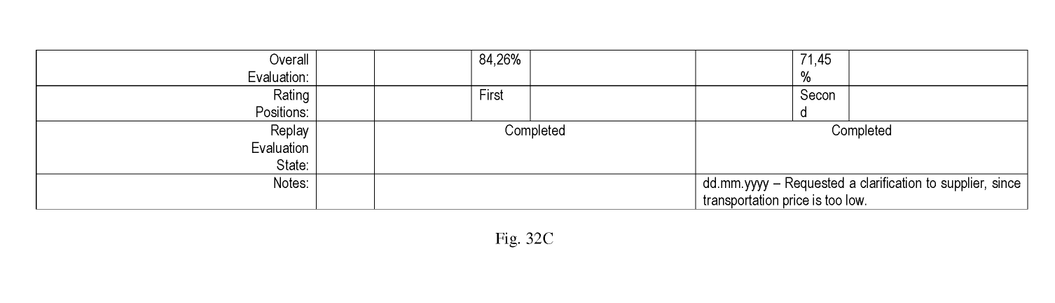

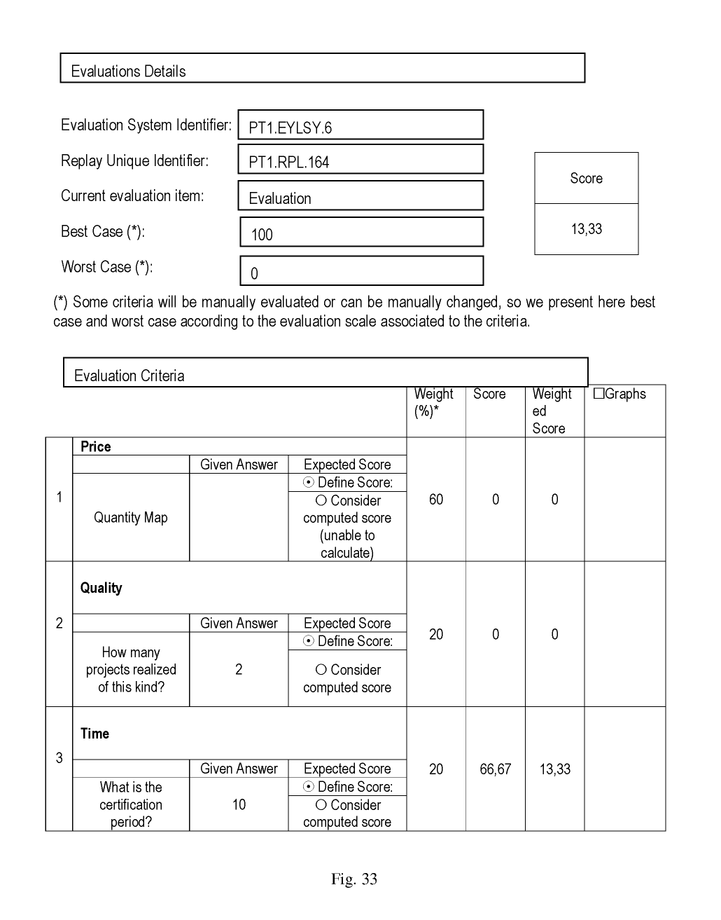

FIG. 6 describes how an Evaluation Analysis can be divided into several “sheets”, before we obtain the final comparable results.
One sheet by evaluator, when the request requires that more than an evaluator analyzes each criteria;
One sheet by criteria, that has question evaluation model, when evaluators are dealing with complex questions.

Global evaluation analysis is a resume map, that gathers the analysis made by each evaluator and to each complex criteria (that can also be analyzed by more than on evaluator).

It is in global evaluation analysis that the evaluators final decision is registered and that replies are properly ranked, to prepare the award.

System must be able to suggest a global evaluation analysis based on the individual analysis of each evaluator. This implies an area to configure those aggregation rules.

FIG. 7 describes how from the Evaluation Module Homepage the user has access to all managers related to evaluation. Information is grouped in four blocks: components to create an evaluation system, weighted model templates, evaluation teams and request evaluations.

FIG. 8 describes how from the eValuation Module Homepage the user can choose to manage the evaluators. When he goes to that option, the below manager is opened, showing the evaluators groups and users already defined. According to permissions, user can add/remove groups and evaluators.

FIG. 9 describes how from the eValuation Module Homepage user can choose to manage evaluation systems. In the management page user can create, activate, deactivate and delete evaluation systems. An evaluation system defines a combination of scores, criteria, value function and evaluators that, put together as a hole or as a sub-set, can originate a weighted model template.

FIG. 10 describes how from the Evaluation System Manager user can choose to create a new evaluation system. This form consists of just one step, where he identifies the system and defines which criteria will be evaluated and who will be the system evaluators.

FIG. 11 describes an example of an evaluation system, that can be viewed from the evaluation system manager.

FIG. 12 describes how from the Evaluation Module Homepage user can choose to manage question types. This option will only be available to the platform manager. The question types defined here are the ones that can be used in marketplace questionnaires.

FIG. 13 describes how from the Evaluation Module Homepage user can choose to manage evaluation scores. Here user can create, edit, activate, deactivate and delete evaluation scores.

FIG. 14 describes how when the user decides to create or edit an evaluation score, the below form is opened. An evaluation score is the range of values that are the outcome of an evaluation system. So, in this form, besides the score identification, user defines a minimum/lower value and a maximum/higher value. It applies to all criteria used in the same evaluation system. It also defines if the score can be given with decimals or not.

FIG. 15 describes an example of an evaluation score.

FIG. 16 describes how from the Evaluation Module Homepage user can choose to manage value function types. Here user can create, edit, activate, deactivate and delete value function types.

FIG. 17 describes a value function type defines how the associated value functions will be defined, that is, what information will be needed to create those functions.

FIG. 18 describes examples of value functions are Qualitative (by points), Quantitative by intervals and Quantitative (math function).

FIG. 19 describes how from the Evaluation Module Homepage user can choose to manage value functions. Here user can create, edit, activate, deactivate and delete value function.

FIG. 20 describes how a specific criteria will be measured, that is, how the input values from a criteria will be transformed into a score. Information needed to create the value function depends on the value function type it is associated with.

FIG. 21 describes the example of a value function of the type Quantitative by Intervals. The variables allow the function to be reusable, since the parameters become dynamic (they must be specified in each request/criteria the function is used).

FIG. 22 describes the example of a value function of the type Quantitative by Math Function. The difference for the intervals type is that instead of defining the several intervals, user specifies a math function to define the function.

FIG. 23 describes the example of a function of the type Qualitative. In this kind of functions, user defines some points/values that can be given to the evaluated reply, to transform it in a score.

FIG. 24 describes from the Evaluation Module Homepage user can choose to manage criteria. Here user can create, edit, activate, deactivate and delete criteria.

FIG. 25 describes how a criteria is something the user wants to evaluate and that is defined by getting some inputs and then, according to a value function, transform it into a score. When defining a criteria, user not only defines the input data to measure it and how it is gathered, but also what value function can be used to evaluate the criteria.

FIG. 26 describes how from the Evaluation Module Homepage the user can choose to manage weighted models. Here the user can create, edit, activate, deactivate and delete weighted model.

FIG. 27 describes how from the Evaluation Module Homepage user can choose to create a new weighted model template. A weighted model template is a fully specified template that users will be able to select and associate with a specific request. It defines the evaluation score that will be used to measure the criteria, all the criteria that will be evaluated, their weights to the global score, their hierarchical relationship (if applicable) and the scales used to measure each criteria. The weighted model template also has a type, to define if it is a global template (made available by the platform manager), a private template (created by the company and not shared) or a shared template (created by the company or other company and shared with the other companies in the market).

FIG. 28A/B describes how on this case, only the “child” criteria are evaluated, the “father” evaluation is the result of their “children” evaluation. Each “child” criteria must have an associated value function to measure it, unless a criteria from other evaluation system is selected. In that case, the value function is a “black-box”, only known by the evaluators of that evaluation system.

FIG. 29 describes how from the Request Form users from companies that have the Evaluation Module have the option to associate an Evaluation Model with their requests. The Evaluation Model can be created from an Weighted Model Template or manually from scratch. In the evaluation model, the user specifies the exact values for the variables and will associate specific questions with each criteria.

FIG. 30 describes how from the Evaluation Module Homepage the user can choose to manage their requested evaluations. Here the user can only view the requests where he has accesses to. He can view the global evaluation or the individual evaluation, according to authorizations. From the individual or global evaluation maps, the user can “drill-down” to specific maps for each kind of criteria.

FIG. 31 describes how from the Request Evaluation Manager the user can choose to view the individual evaluation, where the user can evaluate and add notes to the items under his/her evaluation responsibility.

FIG. 32A/B/C describes how from the Request Evaluation Manager user can choose to view the global evaluation, where he can check which items are already evaluated by whom and which are missing. There is also a “global evaluation” column, that is the one calculated according to the rules defined for getting consensus about a criteria/reply, when more than one evaluator analyzed that criteria/reply.

FIG. 33 describes an example of issues that the vendor may have the answer. As indicated in the figure, it can simulate the assessment by using the “Simulate Evaluation.” In the figure is an example of the main form in which the supplier may consult the model used by the buyer for its assessment of the quantitative part. The vendor may amend its proposal and recalculate the review.

### DETAILED DESCRIPTION

A screen is used to associate questions created in the request questionnaire with each criteria from the evaluation model. For complex questions, user can associate a specific sub-item to the criteria. Instead of a question, the user can associate one of the buyers predefined global indicators. These are indicators that evaluate the suppliers without requiring them to answer questions (for instance, their classification in the internal suppliers system).

Consider a request evaluation model in view mode. In this view, user can not only view data from the model, but also each value function graphic (when applicable).

For each specific request, the user must define the evaluators of each criteria, based on two pieces of information:
The evaluators and evaluation teams associated with the Evaluation System;
The users authorizations for the Business Operation associated with the specific request.

It is here also that user defines the rules for global evaluation, when more than one evaluator evaluates each criteria.

After receiving and opening all replies, evaluators can create evaluation analysis, that will allow to evaluate each reply and to compare globally or criteria by criteria. Evaluations are always created for a specific request. User must identify the analysis and which replies to that specific request he'll want to evaluate. Analysis type is where it is defined what is the purpose of the analysis: Award Request, Qualify Companies for next phase, Qualify Requests for Negotiation round or Qualify Items for a Catalogue. Analysis Decision Level is where it is defined if data selection is made at the reply level, lot level or item level.

As regards the data architecture, the entire process described below is supported by an electronic platform, available in System Platform As A Service, resting on a cloud computing architecture.

The platform architecture assumes the existence of three layers: a database where all information is stored, an application layer, where do all the programs that process information and a presentation layer, responsible for rendering the information presented customer in your browser. This means that all information recorded by users is done using a web browser installed on the machine for each user (client). Access to information is controlled by the prior user authentication (username and password). Depending on the sensitivity of the information requested, the authentication requirements can involve the use of digital certificates for authentication, duly recognized by the platform.

The user has access to screens that allow to view and enter information. When the user confirms that any information which can be stored in the database, this information is transmitted from the client to the server via XML messages properly encrypted, where they are stored.

Thus, each user with access to stored information can later access it from any client with Internet access. After validating the user's authority to visualize the information, the server sends this information to the client for XML message.

Purpose of the process: greater transparency and automation in the evaluation process, without increasing the effort spent on task; functionality directed mainly to the contracting authority; support the evaluation process in highly complex procedures with; to test the evaluation model in order prior to its application, using the proposed simulated; support the negotiation process, when applicable, as necessary to anticipate the changes that each competitor has to do with its initial proposal in order to improve their position; Automate the administrative process of assessment, with the possibility of: Reuse of assessment models; Division of the evaluation process by various stakeholders; Traceability of all assessment decisions; More time available for value-added tasks (analysis of the proposal/negotiation) than for administrative tasks.

### Advantages for the Supplier:

Meet in a transparent model of assessment that its proposal will be subject Possibility to simulate the impacts of different alternatives in the ranking of your proposal before submitting it to the contracting authority (particularly relevant in situations in which each player can only submit one proposal).

Procedure for each buyer, proactively in a specific module management evaluation models:

Creates models of assessment that you want to use; In each model, defines the various evaluation criteria and possible to use the formulas for calculating each criterion (in this first phase only linear functions and simple, but it is intended that any function can be used in the medium term). It is possible that each evaluation criterion is divided into sub-assessment criteria (for example, the criterion price is divided into sub-criteria price of the product price and maintenance). When a criterion is divided into sub-criteria, has a special formula of calculation, the result obtained is the result of weighted sub-criteria that compose it. For each formula identifies the variables that contribute to the calculation of this formula. For the calculation of a complex evaluation criterion is possible to use a different valuation model (a submodel evaluation). The buyer may define within each type of evaluation, various rating systems, which are nothing more than the weighting of the various evaluation criteria, so that the sum of all weights is equal to unity (100%). Define teams of evaluators, indicating who is responsible for each type of assessment. This assignment can be apply the various models of assessment, to see which model fits over the desired result. This allows tuning of the model to anteriori, anticipating what might happen with the proposals received.

### In the Context of Procedure:

In each procedure that is created, the buyer sets the valuation model that you want applied to evaluate the proposals it will receive. If already created the model for assessing the evaluation module, simply select the model to evaluate the use and review the weighting given to different criteria. If not created valuation models then will be able to create the model evaluation in the context of the procedure, this after being available for use in subsequent proceedings.

As stated previously, the evaluation criteria are calculated using functions, in turn, are composed of variables. Thus, in each evaluation criterion the buyer has to define the function parameters that are the user's responsibility (for example, the minimum price and maximum price acceptable for calculation of the criterion price or the maximum delivery time for the calculation of the criterion level of service) and as source for the parameters that are dependent on the response of each provider (for example, which is the point where to read the value of the final price of the item X to calculate the criterion of the issue price or where to read the value of the delivery of the order, to calculate the criterion level of service). That is, in the context of a procedure, the buyer sets the boundaries (“beacons”) defines acceptable and which are read the exact values of each competitor.

In the case of qualitative criteria, although not always possible to define an objective evaluation (eg, Good, Fair, Poor) and a description as possible of the actual requirements be taken into analysis to classify the proposals in each of these possible values.

The buyer also has the ability to allow or not allow competitors access to details of the evaluation model, in order to simulate their proposals.

Bidders record their proposals and, if available, simulation evaluation of their proposals. For the subjective criteria (manual calculation), the bidder will have to manually enter the assessment of how the buyer feels that will evaluate the proposal, given the information available. After the bid opening, each member of the jury have access to the content of proposals to help you assess the criteria of the evaluation model assigned to you (the system is the segmentation of information, allowing access to answers is conditioned upon the access rules configured in the evaluation model, upon the establishment of assessment teams).

It is possible that the same evaluation criterion is assigned more than one evaluator, in which case, the evaluation model has to define what is the criterion for calculating the final score (average, better evaluation, assessment worst, manual selection). In the criteria/proposals with multiple assessments when there is conflict, if there is no automatic method of tie (in which case the option is “Manual selection”), it is the “owner” of the evaluation model (jury president) decision to tiebreaker.

In the definition of the teams you can define whether the jury can see the contents of the proposals which do not relate directly about your criteria or not.

The system allows each criterion is calculated automatically (when the type of function allows), but always left to the discretion of the assessor responsible for the review of this criterion value. The system only allows each evaluator to assess the criteria/proposals they are responsible. When it finishes its assessment of a proposal/criteria, the assessor must “finish” their evaluation. After all proposals/criteria were evaluated, the president of the jury “completes” the evaluation of the procedure, allowing the start of the next phase (negotiation or award).

With the complete award, in addition to having all the information on the evaluation of each proposal on each criterion, it is possible to analyze all this information, the criterion, as proposed by the evaluator, by type of test, . . . .

The above described embodiments are straightforwardly combinable.

The invention is of course not in any way restricted to the embodiments described and a person with ordinary skill in the art will foresee many possibilities to modifications thereof without departing from the basic idea of the invention as defined in the appended claims.

The following claims further set out particular embodiments of the invention.

What is claimed:

1. A multiple criteria, multi-level evaluation method, namely for proposals from bids in a purchasing process, comprising defining an evaluation team or teams, defining which individuals of the team evaluate which metrics, resolving possible conflicts between different scores by different individuals and/or teams for the same metrics, defining which criteria to use in order to aggregate scores—minimum, maximum, average, manually, and establishing scoring functions for each variable and aggregation functions for establishing overall scores.

2. The method of claim 1, wherein the aggregation functions are highly hierarchical merging scores from multiple variable levels.

3. A multiple criteria, multi-level evaluation tool, for proposals from bids in a purchasing process, comprising:
a controller configured to define an evaluation team or teams, and further defining which individuals of the team evaluate which metrics,
wherein the controller resolves possible conflicts between different scores by different individuals and/or teams for the same metrics, and the controller is configured to define which criteria to use in order to aggregate scores including minimum, maximum, average, manually;
an output structure including at least one of an internet connection, an electronic screen, and a printer, wherein the controller establishes scoring functions for each variable and aggregation functions for establishing overall scores which are then communicated to a user via the output structure.
